(19) United States
(12) Patent Application Publication
(10) Pub. No.: US 2003/0193319 A1
(43) Pub. Date: Oct. 16, 2003

(54) Ion powered platform

(76) Inventors: James Rick Wood, Grapevine, TX (US); Mark K. Browder, Frisco, TX (US)

Correspondence Address: WILLIAMS, MORGAN & AMERSON, P.C., 10333 RICHMOND, SUITE 1100, HOUSTON, TX, 77042, US

(21) Appl. No.: 10/121,226

(22) Filed: Apr. 12, 2002

(51) Int. Cl. H02P 9/00

(52) U.S. Cl. 322/2 A

(57) ABSTRACT

An apparatus and method for powering a platform from an ambient electrostatic gradient are disclosed. The apparatus includes an ion powered platform comprises a platform body, an electrical load carried by the platform body; and an electrically conductive probe. The electrically conductive probe is electrically connected to the electrical load at a first point thereon and adapted to generate electrical energy from an ambient electrostatic field gradient. The electrically conductive probe extends from the electrical load such that a second point thereon is vertically displaced from the first point and on the opposite connection of the load. The method includes comprises positioning a first point on an electrically conductive probe at least a predetermined vertical distance from a second point on the electrically conductive probe at which the electrically conductive probe is electrically connected to the electrical load; initiating relative movement between an ambient atmosphere and the electrically conductive probe; and supplying energy generated by an electrical potential created by initiating the relative movement to the electrical load.

### BACKGROUND OF THE INVENTION

1. Field of the Invention

The present invention pertains to an electronic power supply, and, more particularly, to a method and apparatus for powering an electronic device from an ambient (i.e., naturally occurring, as opposed to man-made) electrostatic field gradient.

2. Description of the Related Art

Technological advances enable ever smaller, more capable tools and devices. Electronic components continue to shrink in size while increasing the power of their applications. One example of this phenomenon is the ubiquitous microprocessor that forms the heart of the personal computer. However, the fabrication and design techniques underpinning this phenomenon are applicable to other active and passive electronic components. At the same time, electronic components are finding their way into a broader range of applications. These factors contribute to a discernible trend toward smaller, more capable, and more powerful tools and devices in many areas.

One factor nevertheless continues to retard this trend—power. All these electronic components require electrical power. Furthermore, their power consumption typically rises as the size decreases and the capability increases. Power is typically supplied either by a battery or through an electrical cord connected to a powered electrical grid or a generator. Batteries continue to be relatively large and heavy despite recent, significant advances in battery technology. Connection to a power grid and/or generator brings numerous limitations regarding portability and convenience arising from the umbilical/electrical cord.

The present invention is directed to resolving, or at least reducing, one or all of the problems mentioned above.

### SUMMARY OF THE INVENTION

The invention includes an apparatus and method for powering a platform from an ambient electrostatic gradient.

Thus, in a first aspect of the invention, an ion powered platform comprises a platform body, an electrical load carried by the platform body; and an electrically conductive probe. The electrically conductive probe is electrically connected to the electrical load at a first point thereon and adapted to generate electrical energy from an ambient electrostatic field gradient. The electrically conductive probe extends from the electrical load such that a second point thereon is vertically displaced from the first point and on the opposite connection of the load.

In a second aspect, the invention includes a method for powering an electrical load on an ion powered platform with ions. The method comprises positioning a first point on an electrically conductive probe at least a predetermined vertical distance from a second point on the electrically conductive probe at which the electrically conductive probe is electrically connected to the electrical load; initiating relative movement between an ambient atmosphere and the electrically conductive probe; and supplying energy generated by an electrical potential created by initiating the relative movement to the electrical load.

### BRIEF DESCRIPTION OF THE DRAWINGS

The invention may be understood by reference to the following description taken in conjunction with the accompanying drawings, in which like reference numerals identify like elements, and in which:

FIG. 1 conceptually depicts, in a partially sectioned perspective view, one particular embodiment of an ion powered platform constructed in accordance with the present invention;

FIG. 2A to FIG. 2F depicts alternative embodiments of the electrically conductive probe of the ion powered platform of FIG. 1 implemented in electrically conductive solids;

FIG. 3 conceptually depicts an alternative embodiment in which an ionization source is located at the distal end of an electrically conductive probe;

FIG. 4 conceptually depicts another alternative embodiment employing a secondary ionization source to enhance ionization efficiency;

FIG. 5A and FIG. 5B illustrate the operation of embodiments employing a primary ionization source and a primary and a secondary ionization source, respectively;

FIG. 6A and FIG. 6B conceptually depict yet another alternative embodiment in which the ion powered platform is stationary;

FIG. 7A and FIG. 7B conceptually depict yet another alternative embodiment in which the electrically conductive probe is implemented in an ionized fluid medium; and

FIG. 8 illustrates a method practiced in accordance with one aspect of the present invention.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

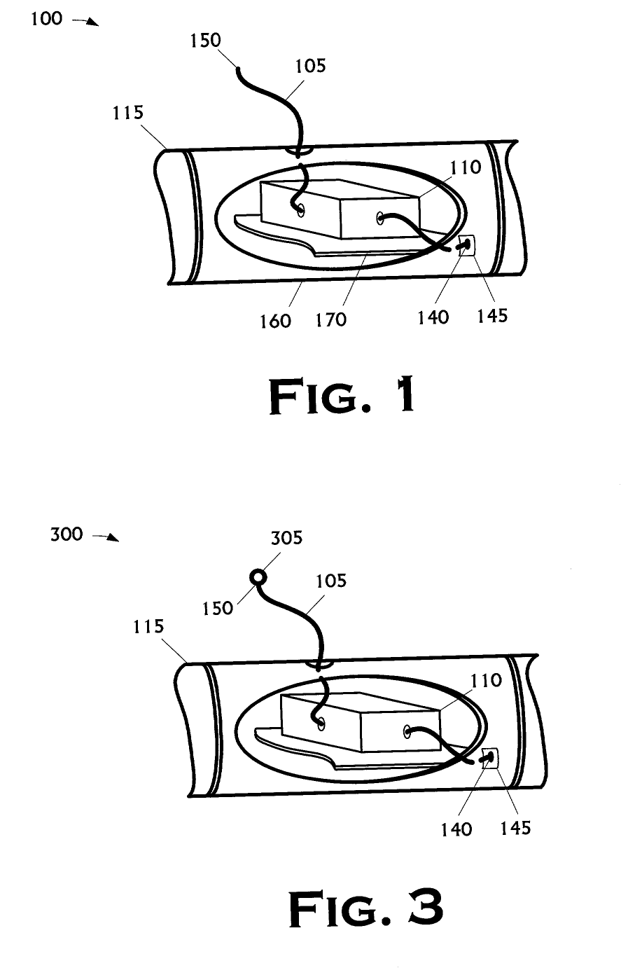

FIG. 1 conceptually illustrates, in a partially sectioned perspective view, one particular embodiment of an ion powered platform 100 constructed in accordance with the present invention. For instance, Earth's atmosphere includes an ambient electrostatic field gradient of approximately 100 to 300 volts per meter over most of Earth's surface, although this varies with, for instance, altitude and weather conditions. The ion powered platform 100 extends an electrically conductive probe 105 at least a predetermined vertical distance to utilize this electrostatic field gradient to power an electrical load 110. The movement of the electrically conductive probe 105 through the electrostatic field gradient causes individual molecules in the atmosphere to ionize, thereby generating an electrical potential across the electrically conductive probe 105. This electrical potential is then harnessed to power the electrical load 110. Note that the movement of the electrically conductive probe 105 through the electrostatic field gradient is a relative movement. In other words, the atmosphere streams past the conductive probe 105. This can result from a motive force imparted to or by the ion powered platform 100 causing it to move. Alternatively, this can result from a wind blowing across a stationary, or slow moving, electrically conductive probe 105.

More particularly, the ion powered platform 100 comprises a platform body 115, the electrical load 110 carried by the platform body 115, and the electrically conductive probe 105. The electrically conductive probe 105 is electrically connected to the electrical load 110 and is electrically grounded at a first point 140. In the illustrated embodiment, the first point 140 is grounded by electrically connecting it to an electrically conductive patch 145 on the fuselage 170 of the airframe 160. Note that, if the fuselage 170 is fabricated from an electrically conductive material, the first point 140 can be grounded at any point thereon. The electrically conductive probe 105 extends from the electrical load 110 such that a second point 150 thereon is vertically displaced from the first point 140. The electrically conductive probe 105 is adapted to generate electrical energy from an ambient electrostatic field gradient, as is discussed further below

The invention admits wide variation in the implementation of the platform body 115. In the illustrated embodiment, the platform 100 is a flying vehicle, and so the platform body 115 includes an airframe 160 to which the electrical load 110 is mounted and a fuselage 170. Thus, the platform body 115 of the illustrated embodiment houses the electrical load 110, but this is not necessary to the practice of the invention. The electrical load 110 may be left exposed to the ambient environment in some alternative embodiments. Indeed, the ion powered platform 100 may be implemented in alternative embodiments as, for example, a reconnaissance drone or a ground-based robotic vehicle. The ion powered platform 100 need not even be a vehicle, but might alternatively be, e.g., a container made of wood, metal, plastic, or some other material.

The identity of the electrical load 110 will be implementation specific. In the illustrated embodiment, the electrical load 110 is a fuse capacitor. The fuse capacitor charges with electrical energy received from the electrically conductive probe 105 at the first point 140. When the fuse capacitor charges sufficiently, the flying submunition is armed and ready to detonate. However, the invention admits variation in the implementation of the electrical load 110 as wide as that for the ion powered platform body 115. The electrical load 110 may be, for example, in alternative embodiments, a motor, or some high-power, short-burst communications circuitry. The motor may also be a high voltage or a low voltage motor, depending on the implementation.

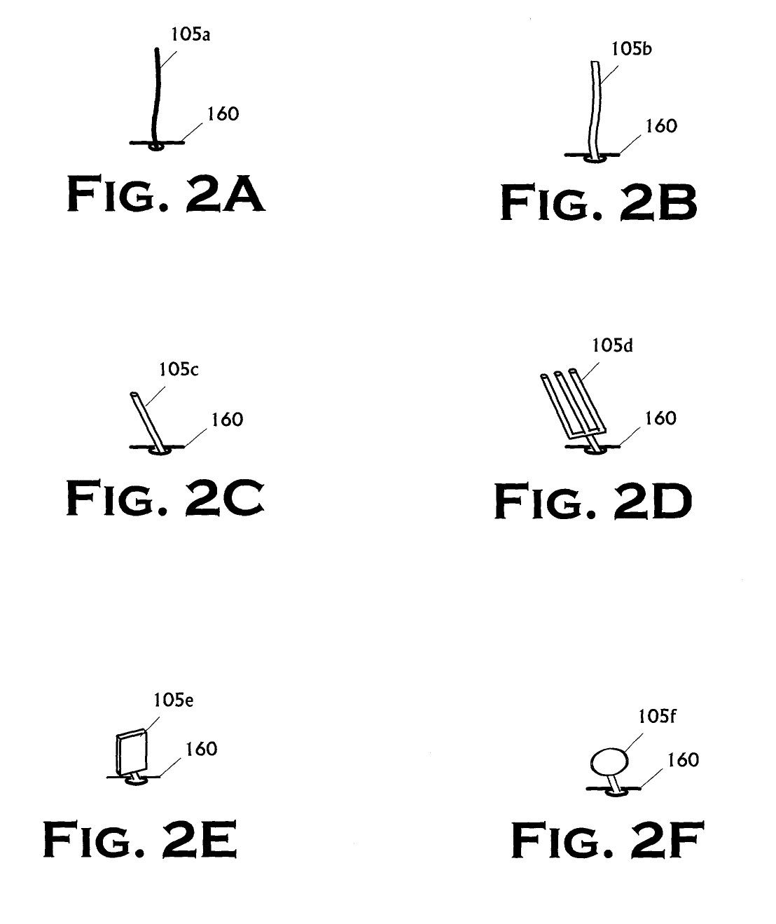

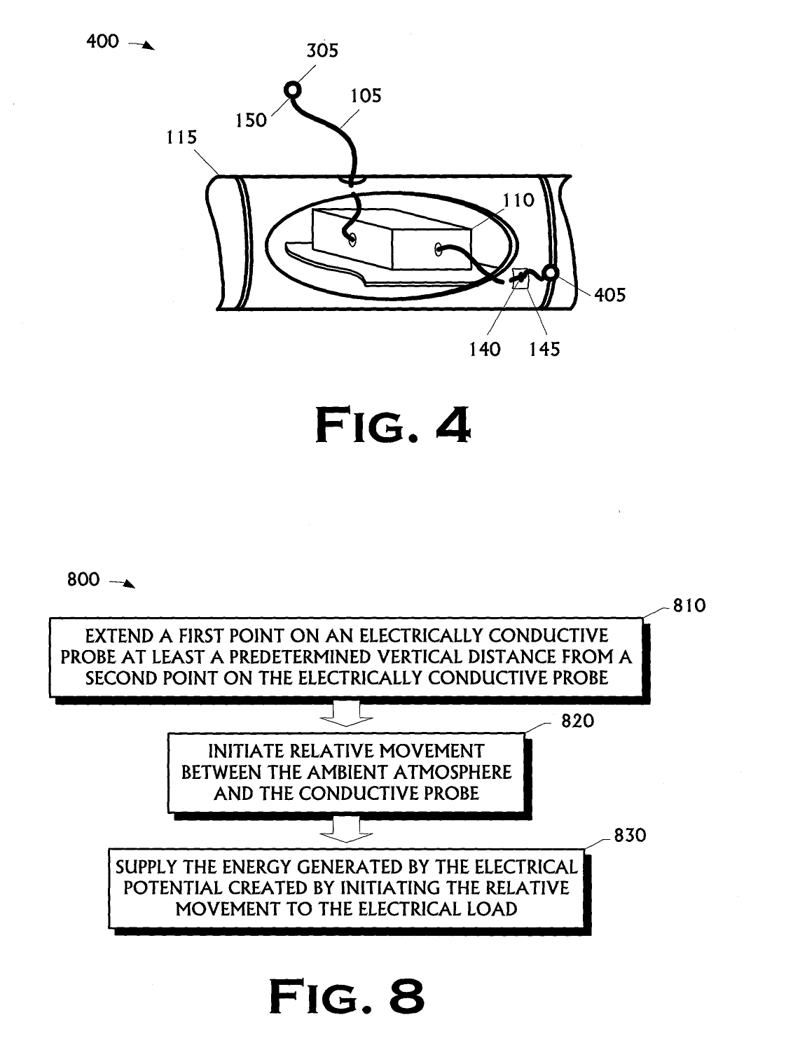

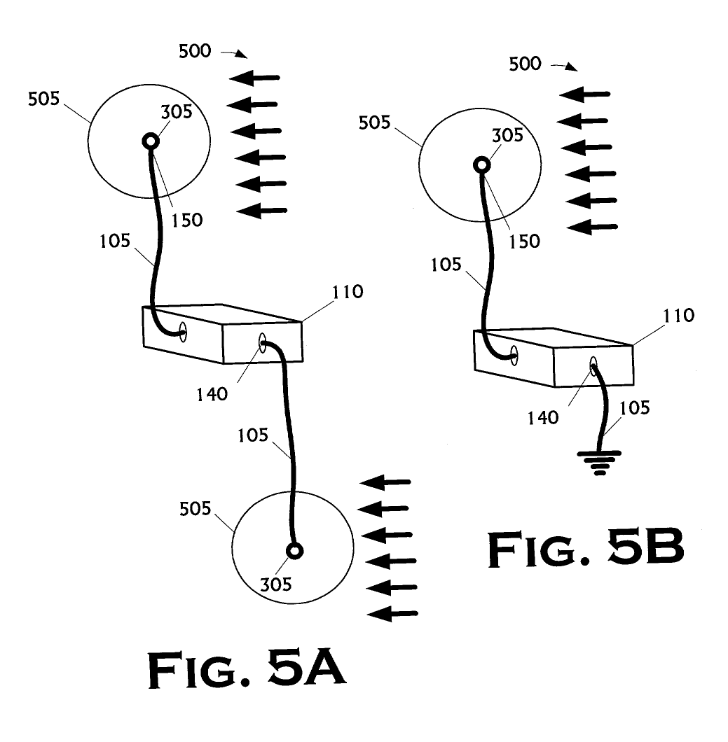

The invention also permits wide variation in implementing the electrically conductive probe 105. The shape and/or geometry of the electrically conductive probe 105 is not material to the practice of the invention. Alternative embodiments are illustrated in FIG. 2A to FIG. 2E. The electrically conductive probe 105 of FIG. 1 may be, for instance:

an electrically conductive fiber 105a, as shown in FIG. 2A;

an electrically conductive ribbon 105b, as shown in FIG. 2B, for instance, woven or otherwise fabricated from electrically conductive fibers (e.g., the electrically conductive fiber 105a) or a flexible material coated by metal or a metallized polymer;

an electrically conductive rod 105c, as shown in FIG. 2C, such as a metallized glass rod;

an array 105d of electrically conductive rods (e.g., the electrically conductive rod 105c) ribbons (e.g., the electrically conductive ribbon 105b), or electrically conductive fibers (e.g, the electrically conductive fiber 105a) as shown in FIG. 2D;

an electrically conductive sheet 105e, as shown in FIG. 2E, fabricated from, e.g., a metal or electrically conductive composite material; or

an electrically conductive ring 105f, as shown in FIG. 2F, fabricated from, e.g., a metal or an electrically conductive composite material.

Thus, the electrically conductive probe 105 may by flexible (e.g., as are the electrically conductive fiber 105a and electrically conductive ribbon 105b) or rigid (e.g., like the electrically conductive rod 105c and electrically conductive sheet 105e). Note also that the vertical displacement between the two most vertically distant points on the electrically conductive probe 105 contributes more significantly to its operation than its actual shape and/or geometry.

The vertical displacement between the two most vertically distant points on the electrically conductive probe 105 will be implementation specific. The vertical displacement will primarily be a factor of the power requirements of the electrical load and the electrostatic field gradient, applied in light of commonly accepted engineering principles. For instance, as was previously mentioned, Earth's electrostatic field gradient varies from approximately 100 to approximately 300 volts per meter in fair weather and at sea level. However, these values will vary with altitude and weather—bad weather, for example, can greatly increase the magnitude. Note that the invention may find extraterritorial application, e.g., on Venus, Mars, or Europa, whose ambient electrostatic field gradients may vary from that of Earth's. Similarly, the power requirements of the electrical load 110 may vary over time as the ion powered platform 100 enters differing operational modes. Similarly, some applications might be more tolerant of power supply faults than are other, thereby providing greater latitude in design.

Another important factor is the volume of ionized air. Greater volumes tend to produce a greater electrical potential. For this reason, implementations of the electrically conductive probe 105 that maximize this volume of ionized air may be generally preferred for most embodiments. The array 105d in FIG. 2D might therefore be preferred over the electrically conductive rod 105c in FIG. 2C. The electrically conductive ribbon 105b in FIG. 2B might also generally be preferred over the electrically conductive fiber 105a in FIG. 2A. However, each implementation may be different, and this principle is not universally applicable to all embodiments.

Still referring to FIG. 1, in one particular implementation, the electrically conductive element 105 is an electrically conductive fiber, or “streamer,” extending from the ion powered platform 100. The first and second points 140, 150 are separated by 100 meters and generate a potential difference of 10,000 volts. In the illustrated embodiment, as was mentioned, this potential is used to charge a fuse capacitor in a flying submunition. However, in alternative embodiments, a high voltage capacitor could be used to, for instance, provide current to a switching circuit to create lower voltage higher current pulses adequate to run a small motor. By utilizing this larger current capability, the ability to deliver energy for useful work is made possible.

Design constraints may make it difficult or impractical to provide the requisite vertical displacement in some implementations. One such embodiment 300 is shown in FIG. 3. In these embodiments, the ionizing effect of the electrically conductive probe 105, shown in FIG. 1, can be enhanced by including an ionization source 305 at the point 150 of the electrically conductive probe 105 most distal from the electrical load 110. For embodiments where the point 140 does not contact the electrical ground 145, the ionization source 305 may be located anywhere on the electrically conductive probe 105, but the point 150 most distal the electrical load 110 may be used to produce enhanced results. Where the electrically conductive probe 105 is an array (e.g., the array 105d in FIG. 2D), each element of the array can include an ionization source 305 on the end thereof. The ionization source 305 contains a low level, radioactive source of alpha or beta particles encapsulated in a suitable material. Suitable alpha emitters include, but are not limited to, isotopes of Polonium and Americium (Am). Suitable beta emitters include, but are not limited to, Tritium. Suitable encapsulating materials include, but are not limited to, glass compositions such as silicate, borosilicate, aluminasilicate, and borate. In some embodiments, the point 150 can be doped with an alpha emitter or a beta emitter during manufacture.

Suitable alpha and beta emitters are commercially available. For instance, suitable alpha emitters are sold under the mark RadSPHERES™ by:

### MO-SCI Corporation

### 4000 Enterprise Drive, P.O. Box 2

### Rolla, Mo. 65402-0002

### 573-364-2338 (ph)

### 573-364-9589(fax)

Additional information is available on the World Wide Web at <http://www.thomasregister.com/olc/mo-scicorp/radsph.htm>. The RadSPHERES™ alpha emitters are glass microspheres of encapsulated low-level radioactive materials. Alternatively, the low-level radioactive material may be encapsulated in a bar-shaped material. However, other commercially available alpha emitters and beta emitters may also be employed.

Some embodiments successfully employ further ionization efficiency than that provided by the ionization source 305 in FIG. 3. One such embodiment 400 is conceptually illustrated in FIG. 4. In FIG. 4, a second ionization source 405 is on or near the electrical load 110 on the end thereof opposite the first point 140 where the electrically conductive probe 105 is electrically connected to the electrical load 110. The second ionization source 405 may, like the first ionization source 305, be any suitable alpha or beta particle emitter. In the illustrated embodiments, the first and second ionization sources 305, 405 are of the same construction and materials, but this is not necessary to the practice of the invention.

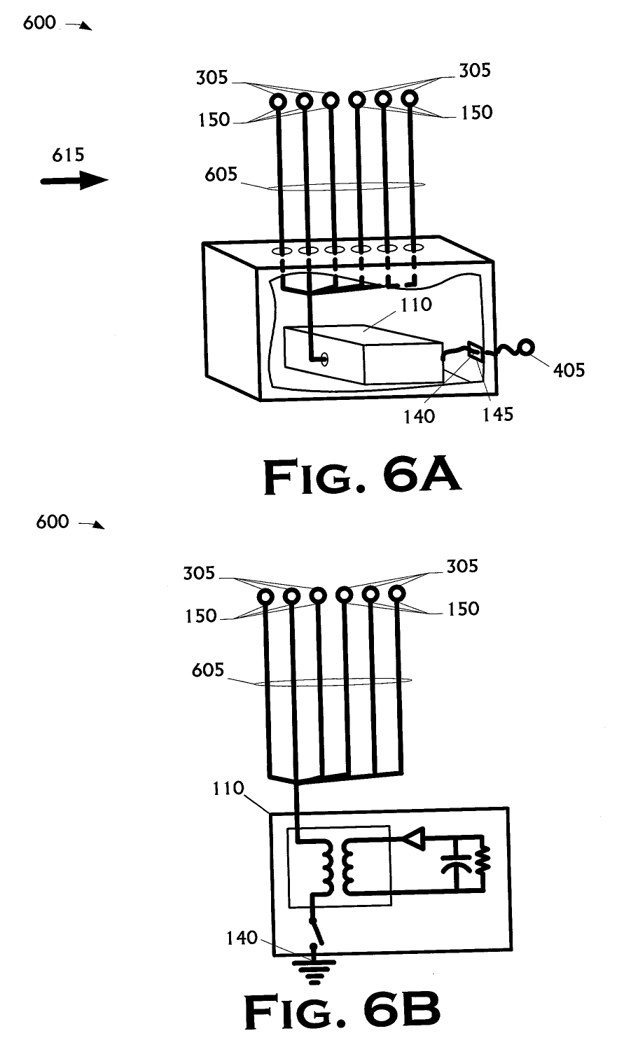

Turning now to FIG. 5A and FIG. 5B, in operation, the relative movement between the electrically conductive probe 105 and the ambient atmosphere, generally indicated by the arrows 500, ionizes the air streaming past the electrically conductive probe 105. Hence, the potential created between the first point 140 and the second point 150 on the electrically conductive probes 105. Each ionization source 305 creates an ionization region 505, which is a volume of air ionized by the ionization source 305 without having to stream past the electrically conductive probe 105. The increase in the volume of ionized air increases the efficiency of the coupling to the electrostatic field gradient in the vicinity of the ionization source 305, which includes at least a portion of the electrically conductive probe 105. Thus, as the ionization sources 305 increase the volume of ionized air, they increase the efficiency of the coupling to the electrostatic field gradient.

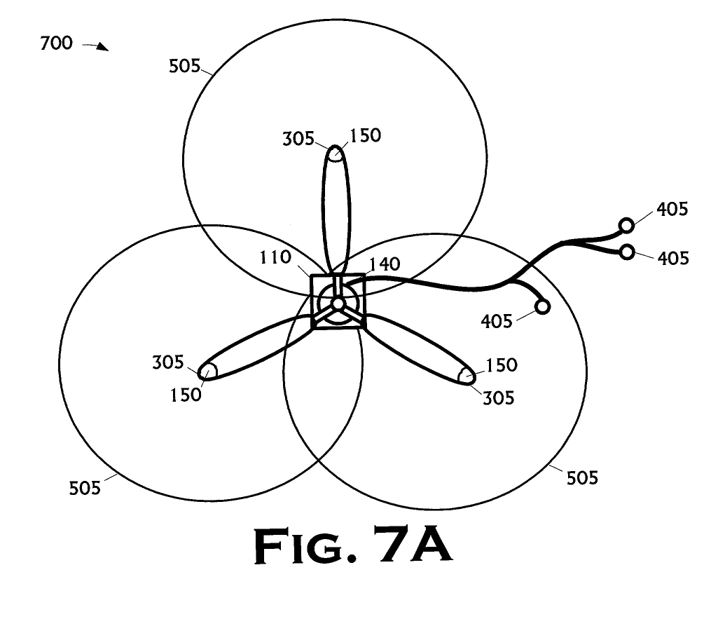

Note that the embodiments described above contemplate that the ion powered platforms 100, 300, 400, move relative to Earth's atmosphere. However, this is not necessary to the practice of the invention. The same effect can be achieved by placing a stationary ion powered platform in a location with air movement. Consider, for instance, the ion powered platform 600 shown in FIG. 6A. The ion powered platform 600 is a sensor, but is stationary. The ion powered platform 600 includes an electrically conductive probe 605 that is an array. The elements of the array 605 are rigid, and each has an ionization source 305 electrically connected to the end thereof as was described above. The ion powered platform 600 also includes an ionization source 405 on the other side of the electrical load 110, which is a capacitor in the illustrated embodiment. FIG. 6B conceptually illustrates the electrical circuit of the ion powered platform 600, first shown in FIG. 6A, which includes a transformer 620. The ion powered platform 600 is then placed in an area expected to consistently experience high winds, represented by the arrow 615. If the winds are high and consistent enough, the fuse capacitor (i.e., the electrical load 110) will charge and the sensor (i.e., the ion powered platform 600) may then be activated.

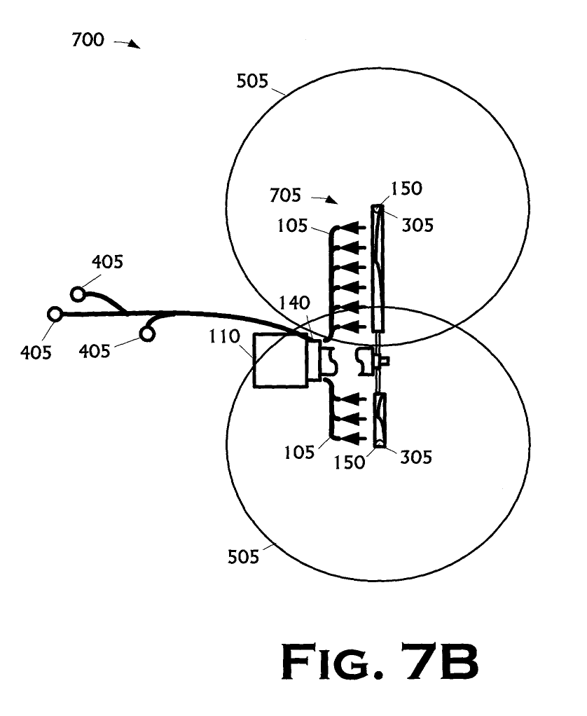

Yet another alternative embodiment 700 is illustrated in FIG. 7A and FIG. 7B. The embodiment 700 is part of a propeller-driven propulsion system for a flying vehicle not otherwise shown. The propeller 705 includes three blades 710. The number of blades 710 is immaterial to the practice of the invention. Each blade 710 is doped at the distal end 715 thereof to produce a primary ionization source 305. Each primary ionization source 305 generates an ionization region 505 as described above relative to the embodiment 500 shown in FIG. 5. The embodiment 700 also includes a secondary ionization source 405. The electrical load 110 in this embodiment is a motor for driving the propeller 705. The motor may be, for example, a surface acoustic wave linear motor, an ultrasonic motor, or an electrostatic motor, depending on the implementation.

The embodiment 700 is launched from another flying vehicle, and so is moving relative to the atmosphere. As is best shown in FIG. 7B, the atmosphere streams past the primary ionization sources 305 on the distal ends 715 of the blades 710 and through the ionization regions 505, as represented by the arrows 720. The ionized atmosphere completes an electrical circuit between the first point 140 (i.e., the electrical ground) on the ring 725 and the second points 150 on the distal ends 715. Thus, the electrically conductive probe 105 in this embodiment is implemented in an ionized fluid medium as opposed to an electrically conductive solid.

Thus, the invention includes, in another aspect, a method 800, illustrated in FIG. 8, for powering an electrical load (e.g., the electrical load 110 in FIG. 1) on a ion powered platform (e.g., the ion powered platforms 100, 300, 400, 600, in FIG. 1, FIG. 3, FIG. 4, and FIG. 6A, respectively) with ions. The method 800 begins by extending a first point on an electrically conductive probe at least a predetermined vertical distance from a second point on the electrically conductive probe at which the electrically conductive probe is electrically connected to the electrical load (at 810). This extension may occur during fabrication, between fabrication and deployment, or after deployment. Next, the method 800 initiates relative movement between the ambient atmosphere and the electrically conductive probe (at 820). Note that the movement is relative. As is apparent from the discussion above, the relative to some fixed point, the ion powered platform may move through the atmosphere, the atmosphere may move over the ion powered platform, or both the ion powered platform and atmosphere may move. Finally, the method 800 supplies the energy generated by the electrical potential created by initiating the relative movement to the electrical load (at 830).

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An ion powered platform, comprising:
a platform body;
an electrical load carried by the platform body; and
an electrically conductive probe electrically connected to the electrical load at a first point thereon and adapted to generate electrical energy from an ambient electrostatic field gradient, the electrically conductive probe extending from the electrical load such that a second point thereon is vertically displaced from the first point and on the opposite connection of the load.

2. The ion powered platform of claim 1, further comprising an ionization source electrically coupled to the second end of the probe.

3. The ion powered platform of claim 2, wherein the ionization source comprises one of an alpha-particle emitter and a beta-particle emitter.

4. The ion powered platform of claim 3, wherein the alpha-particle emitter includes one of Polonium and Americium.

5. The ion powered platform of claim 4, wherein the Polonium or Americium is encapsulated in one of silicate, borosilicate, aluminasilicate, and borate.

6. The ion powered platform of claim 3, wherein the beta-particle emitter includes Tritium.

7. The ion powered platform of claim 2, further comprising a second ionization source affixed to the electrical load at a third point on the electrical load distal from the first point.

8. The ion powered platform of claim 7, wherein the second ionization source comprises one of an alpha-particle emitter and a beta-particle emitter.

9. The ion powered platform of claim 8, wherein the alpha-particle emitter includes one of Polonium and Americium.

10. The ion powered platform of claim 9, wherein the Polonium or Americium is encapsulated in one of silicate, borosilicate, aluminasilicate, and borate.

11. The ion powered platform of claim 8, wherein the beta-particle emitter includes Tritium.

12. The ion powered platform of claim 1, wherein the electrically conductive probe comprises one of a fiber, a ribbon, a rod, a ring, and a sheet.

13. The ion powered platform of claim 12, wherein the fiber comprises an electrically conductive carbon filament.

14. The ion powered platform of claim 13, wherein at least one of the ribbon, the rod, the ring, and the sheet comprises a plurality of electrically conductive carbon filaments, a metallized glass, a metal coating, or a metallized polymer.

15. The ion powered platform of claim 1, wherein the electrically conductive probe comprises
a first ionization source;
a second ionization source; and
an ionized fluid medium between the first and second ionization sources.

16. The ion powered platform of claim 15, wherein at least one of first and second ionization sources comprises one of an alpha-particle emitter and a beta-particle emitter.

17. The ion powered platform of claim 16, wherein the alpha-particle emitter includes one of Polonium and Americium.

18. The ion powered platform of claim 17, wherein the Polonium or Americium is encapsulated in one of silicate, borosilicate, aluminasilicate, and borate.

19. The ion powered platform of claim 16, wherein the beta-particle emitter includes Tritium.

20. An ion powered platform, comprising:
a platform body;
an electrical load carried by the platform body; and
means for generating electrical energy from an ambient electrostatic field gradient.

21. The ion powered platform of claim 20, further comprising a first means for ionizing a region of air, the ionizing means being electrically coupled to the generating means.

22. The ion powered platform of claim 21, wherein the ionizing means comprises one of means for emitting alpha-particles and means for emitting beta-particles.

23. The ion powered platform of claim 21, further comprising second means for ionizing a region of air electrically coupled to the generating means.

24. The ion powered platform of claim 20, wherein the generating means comprises one of a fiber, a ribbon, a rod, a ring, and a sheet.

25. The ion powered platform of claim 20, wherein the generating means comprises:
first means for ionizing a region of air;
second means for ionizing a region of air; and
an ionized fluid medium between the first and second ionizing means.

26. A method for powering an electrical load on an ion powered platform with ions, comprising:
positioning a first point on an electrically conductive probe at least a predetermined vertical distance from a second point on the electrically conductive probe at which the electrically conductive probe is electrically connected to the electrical load;
initiating relative movement between an ambient atmosphere and the electrically conductive probe; and
supplying energy generated by an electrical potential created by initiating the relative movement to the electrical load.

27. The method of claim 26, further comprising providing an ionization source as the first point.

28. The method of claim 27, further comprising providing a second ionization source on the side of the electrical load opposite the second point.

29. The method of claim 26, further comprising providing an ionization source on the side of the electrical load opposite the second point.

30. The method of claim 26, wherein extending the first point on the electrically conductive probe at least the predetermined vertical distance from the second point includes extending on deployment of the ion powered platform.

31. The method of claim 26, wherein extending the first point on the electrically conductive probe at least the predetermined vertical distance from the second point includes extending on manufacture of the ion powered platform.

32. The method of claim 26, wherein initiating the relative movement includes placing the ion powered platform in motion.

33. The method of claim 26, wherein initiating the relative movement includes deploying the ion powered platform in expectation of a desirable wind pattern.
